(19) United States
(12) Patent Application Publication
(10) Pub. No.: US 2026/0249395 A1
(43) Pub. Date: Aug. 27, 2026

(54) WELDING MANAGEMENT DEVICE FOR MANAGING WELDING CONDITIONS OF SPOT WELDING

(71) Applicant: FANUC CORPORATION, Yamanashi (JP)

(72) Inventors: Sayuki KASHIWAGI, Yamanashi (JP); Akinori NISHIMURA, Yamanashi (JP)

(21) Appl. No.: 18/862,949

(22) PCT Filed: May 27, 2022
(86) PCT No.: PCT/JP2022/021810

§ 371 Date: Nov. 5, 2024

(51) Int. Cl. B23K 26/22; B23K 26/08; B23K 26/70

(52) U.S. Cl. CPC B23K 26/22; B23K 26/0884; B23K 26/702

(57) ABSTRACT

This welding management device manages the welding conditions of spot welding. The welding management device comprises a control device and a calculation processing device. The calculation processing device comprises a storage unit for storing welding conditions master data in which the values of items included in welding conditions are composed of reference values.

The control device comprises a history generation unit that creates a change history including the value of an item before a change and the value of the item after the change when the value of an item in the welding conditions is changed. The storage unit stores reference data together with the change history generated by the history generation unit.

### RELATED APPLICATIONS

The present application is a National Phase of International Application No. PCT/JP2022/021810 filed May 27, 2022.

### TECHNICAL FIELD

The present invention relates to a welding management device for managing welding conditions of spot welding.

### Background Art

As a welding apparatus configured to fix members to each other, an arc welding apparatus including a welding torch for welding by arc discharge has been known (e.g., Japanese Unexamined Patent Publication No. 2016-124076A and Japanese Unexamined Patent Publication No. 2006-26655A). There is also known a spot welding apparatus provided with a spot welding gun for welding by energization across between electrodes (e.g., Japanese Unexamined Patent Publication No. 5-220580A). In addition, a robot apparatus is known in which a work tool for performing welding is attached to a robot and the welding is performed while changing a position and an orientation thereof.

In spot welding, a workpiece is pinched between a pair of electrodes and pressed. When a current flows through the electrodes, heat is generated due to resistance. Then, the workpiece is melted and welded at a point with which the electrodes are in contact. In the spot welding, a condition under which a current flows through the electrodes is predetermined as a welding condition. In a welding condition, a pattern of flowing a current, such as a current value or an energization time, is defined.

The welding condition is defined, for example, for each welding point at which spot welding is performed on the workpiece. The welding condition depends on the thickness, shape, material, and the like of a portion of the workpiece on which the spot welding is performed. Therefore, it is Substitute Specification Clean difficult for the operator to determine the optimum welding condition at a time. The operator can determine the optimum welding condition while changing the welding condition.

For example, the operator may perform welding while gradually changing some elements of the welding condition in order to determine the optimum welding condition. Alternatively, the quality of welding after performing the welding is determined, and then the values of some elements of the welding condition are changed in some cases. The welding condition is preserved in, for example, a welding timer that supplies a current to an electrode of a spot welding gun.

### Citation List

### Patent Literature

PTL 1: Japanese Unexamined Patent Publication No. 2016-124076A

PTL 2: Japanese Unexamined Patent Publication No. 2006-26655A

PTL 3: Japanese Unexamined Patent Publication No. 5-220580A

### SUMMARY OF INVENTION

### Technical Problem

In the prior art, when values of some elements of a welding condition are changed, the values of the elements of the welding condition before the change are not preserved. As a result, the past welding condition is not substantially managed. Alternatively, the welding condition including the values of all the elements is stored in a device different from the welding timer. For example, each time a welding condition is changed, the welding condition is stored with a date and a number attached thereto. For this reason, when the past welding condition is to be checked, the operator needs to compare the respective welding conditions to find out a changed element and a changed value. As described above, there is a problem in that the management of the welding condition takes time. In order to manage the welding condition, it is preferable that an element that caused a change in the welding condition and a changed value be easily acquired.

### Solution to Problem

An aspect of the present disclosure is a welding management device that manages welding conditions of spot welding. The welding management device includes a storage part that stores reference data of a welding condition in which a value of an item included in the welding condition is configured by a reference value. The welding management device includes a history generating unit that, when a value of at least one item of the welding condition is changed, generates a change history including a value before the change and a value after the change in the at least one item. The storage part stores the change history generated by the history generating unit together with the reference data.

### Advantageous Effects of Invention

According to an aspect of the present disclosure, it is possible to provide a welding management device that facilitates the management of welding conditions.

### BRIEF DESCRIPTION OF DRAWINGS

FIG. 1 is a perspective view of a robot system including a robot apparatus and an arithmetic processing device in an embodiment.

FIG. 2 is a block diagram of a robot system.

FIG. 3 is an explanatory diagram when creating master data of a welding condition in an embodiment.

FIG. 4 is an explanatory diagram when generating a change history of a welding condition in an embodiment.

FIG. 5 is a diagram for explaining updating of a welding condition stored in a welding timer.

FIG. 6 is a first diagram describing restoration of a welding condition at an optional time point in the past.

FIG. 7 is a second diagram describing restoration of a welding condition at an optional time point in the past.

FIG. 8 is a diagram describing restoration of some elements of a welding condition at an optional time point in the past.

FIG. 9 is a block diagram of another robot system in an embodiment.

### DESCRIPTION OF EMBODIMENTS

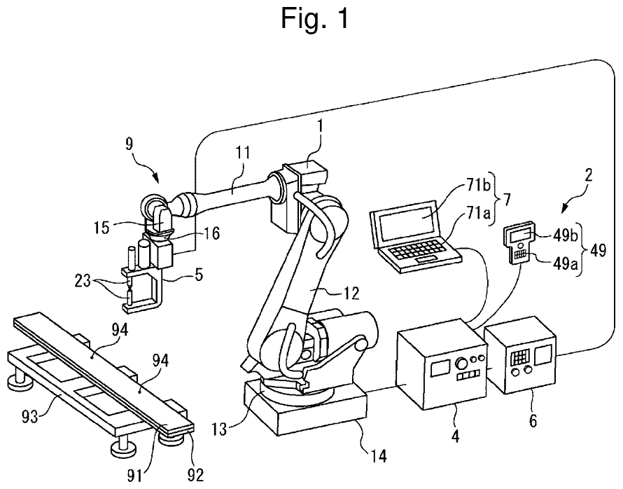

A welding management device in an embodiment will be described with reference to FIG. 1 to FIG. 9. The welding management device in the present embodiment manages welding conditions of spot welding. In the present embodiment, as a welding apparatus, a robot apparatus including a spot welding gun will be exemplified and described.

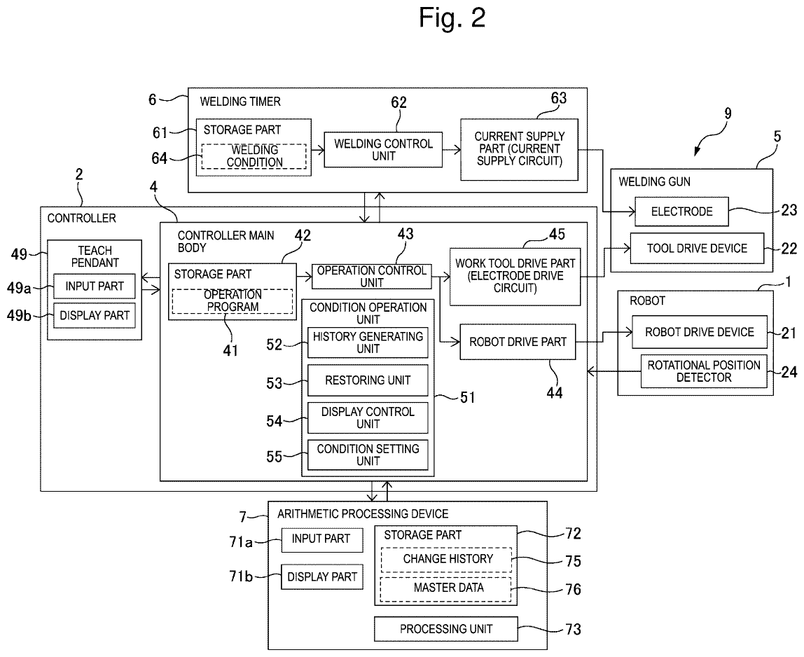

FIG. 1 is a perspective view of a robot system in the present embodiment. FIG. 2 is a block diagram of the robot system in the present embodiment. Referring to FIG. 1 and FIG. 2, the robot system includes a robot apparatus 9 and an arithmetic processing device 7 connected to a controller 2 of the robot apparatus 9. The robot apparatus 9 can perform welding at a desired welding point 94 while changing a position and orientation of a welding gun 5. The robot apparatus 9 includes the welding gun 5 as a welding work tool, a robot 1 configured to change the position and orientation of the welding gun 5, and a welding timer 6 configured to supply a current for welding to electrodes 23 of the welding gun. The robot apparatus 9 includes the controller 2 configured to control operations of the robot 1 and the welding gun 5.

Workpieces 91 and 92 of the present embodiment are plate-like members. The workpiece 92 has a planar shape identical to that of the workpiece 91. The workpieces 91 and 92 are fixed to a platform 93 by a jig (not illustrated). The robot apparatus 9 performs spot welding at a plurality of the welding points 94. By performing the spot welding, the workpiece 91 and the workpiece 92 are fixed to each other.

The robot 1 of the present embodiment is an articulated robot including a plurality of joints. The robot 1 includes an upper arm 11 and a lower arm 12. The lower arm 12 is rotatably supported by a swivel base 13. The swivel base 13 is rotatably supported by a base 14. The robot 1 includes a wrist 15 connected to an end portion of the upper arm 11. The wrist 15 includes a flange 16 for fixing the welding gun 5. The robot 1 of the present embodiment includes six drive axes, but is not limited to this configuration. Any robot that can move the work tool can be employed.

The robot 1 of the present embodiment includes a robot drive device 21 configured to drive constituent members, such as the upper arm 11. The robot drive device 21 includes a plurality of drive motors for driving the upper arm 11, the lower arm 12, the swivel base 13, the wrist 15, and the flange 16. The welding gun 5 includes a tool drive device 22 for driving the welding gun 5. The welding gun 5 includes the electrodes 23 facing each other. In the present embodiment, one electrode 23 is a fixed electrode and the other electrode 23 is a movable electrode. The tool drive device 22 of the present embodiment includes a motor that drives the movable electrode relative to the fixed electrode.

The robot 1 includes a state detector for detecting the position and orientation of the robot 1. The state detector in the present embodiment includes a rotational position detector 24 attached to the drive motor of each drive axis of the robot drive device 21. The rotational position detector 24 is constituted of, for example, an encoder. The position and orientation of the robot 1 are detected from the output of the rotational position detector 24.

The controller 2 includes a controller main body 4 provided with an arithmetic processing device (computer) including a central processing unit (CPU) as a processor. The arithmetic processing device includes a random access memory (RAM), a read only memory (ROM), and the like, which are mutually connected to the CPU via a bus. The controller 2 drives the robot 1 and the welding gun 5 based on an operation program 41 created in advance. The robot apparatus 9 in the present embodiment automatically performs spot welding on the workpieces 91 and 92 at the welding point 94.

The arithmetic processing device of the controller main body 4 includes a storage part 42 configured to store information regarding the control of the robot apparatus 9. The storage part 42 may be constituted by a non-transitory storage medium capable of storing information. For example, the storage part 42 may be constituted by a storage medium such as a volatile memory, a nonvolatile memory, a magnetic storage medium, or an optical storage medium. The operation program 41 for performing the spot welding by the robot apparatus 9 is stored in the storage part 42.

The arithmetic processing device of the controller main body 4 includes an operation control unit 43 configured to transmit operation commands. The operation control unit 43 transmits an operation command for driving the robot 1 to a robot drive part 44 based on the operation program 41. The robot drive part 44 includes an electric circuit that drives the drive motors. The robot drive part 44 supplies electricity to the robot drive device 21 in accordance with the operation command.

The operation control unit 43 also sends, to a work tool drive part 45, an operation command for driving the tool drive device 22. The work tool drive part 45 includes an electrical circuit (electrode drive circuit) configured to drive a motor of the movable electrode. The work tool drive part 45 supplies electricity to the tool drive device 22 based on the operation command.

The operation control unit 43 corresponds to a processor that drives in accordance with the operation program 41 of the robot apparatus 9. The processor functions as the operation control unit 43 by reading the operation program 41 and performing the control defined in the operation program 41.

The welding timer 6 controls the current supply such as the magnitude of the current supplied to the electrode 23 of the welding gun 5, the timing at which the current flows, and the rate of change in the current. The welding timer 6 of the present embodiment includes an arithmetic processing device including a CPU as a processor. The arithmetic processing device of the welding timer 6 includes a welding control unit 62 for controlling the current. The arithmetic processing device of the welding timer 6 is formed to be able to communicate with the arithmetic processing device of the controller main body 4. The welding control unit 62 receives a command to supply electricity to the electrode 23, from the operation control unit 43. The welding control unit 62 receives, for example, a command to supply electricity based on a welding condition number.

The arithmetic processing device of the welding timer 6 includes a storage part 61 configured to store information regarding the control of the current to be supplied to the spot welding gun. The storage part 61 may be constituted by a non-transitory storage medium capable of storing information. For example, the storage part 61 may be constituted of a storage medium such as a volatile memory, a nonvolatile memory, a magnetic storage medium, or an optical storage medium. The storage part 61 stores a program for controlling the current by the welding timer 6, and a welding condition 64 to be satisfied when performing the welding.

The welding timer 6 includes a current supply part 63 including a current supply circuit for supplying a current to the electrode 23. The current supply part 63 supplies electricity to the electrode 23 of the welding gun 5 based on a command from the welding control unit 62. The welding control unit 62 corresponds to a processor that drives in accordance with the program for the control of the current. The processor reads the program and performs the control defined by the program, thereby functioning as the welding control unit 62.

The controller 2 includes a teach pendant 49 as an operation panel through which an operator manually operates the robot apparatus 9. The teach pendant 49 includes an input part 49a for inputting information regarding the control of the robot apparatus 9. The input part 49a includes operation members such as a keyboard and a dial. The teach pendant 49 includes a display part 49b configured to display information regarding the control of the robot apparatus 9. The display part 49b of the present embodiment displays information related to the welding. The display part 49b is constituted of a display panel such as a liquid crystal display panel or an organic electro luminescence (EL) display panel. In a case where the display panel is constituted of a display panel of a touch panel type, the display panel functions as the input part and the display part.

The arithmetic processing device of the controller main body 4 includes a condition operation unit 51 for operating a welding condition. The condition operation unit 51 includes a history generating unit 52 configured to generate a change history of the welding condition. When a value of at least one element of the welding condition is changed, the change history of the present embodiment includes a value before the change and a value after the change in the at least one element. The change history of the present embodiment is generated not having a relative value of the welding condition value, but having the welding condition value (absolute value).

The condition operation unit 51 includes a restoring unit 53 for restoring values of elements of the past welding condition. The condition operation unit 51 includes a display control unit 54 configured to control an image displayed on the display part 49b of the teach pendant 49. The condition operation unit 51 includes a condition setting unit 55 configured to set a welding condition for actual welding. The condition setting unit 55 sets a welding condition for actual welding in response to the operation of the input part 49a by the operator. Each of the condition operation unit 51, the history generating unit 52, the restoring unit 53, the display control unit 54, and the condition setting unit 55 corresponds to a processor that drives in accordance with the operation program 41. The processor functions as each unit by reading the operation program 41 and performing the control that is defined in the operation program 41.

The robot system of the present embodiment includes the arithmetic processing device 7 formed to be able to communicate with the arithmetic processing device of the controller main body 4. The arithmetic processing device 7 is constituted of a computer including a CPU as a processor. The arithmetic processing device 7 includes an input part 71a, with which the operator inputs information. The input part 71a includes operation members such as a keyboard and a dial.

Further, the arithmetic processing device 7 includes a display part 71b configured to display information related to the welding. The display part 71b can be constituted of any display panel able to display an image. The display part 71b can be constituted of a display panel such as a liquid crystal display panel or an organic EL display panel.

The arithmetic processing device 7 includes a storage part 72 configured to store information regarding the welding. The storage part 72 may be constituted by a non-transitory storage medium capable of storing information. For example, the storage part 72 can be constituted of a storage medium such as a volatile memory, a nonvolatile memory, a magnetic storage medium, or an optical storage medium. The arithmetic processing device 7 includes a processing unit 73 configured to process information. The processing unit 73 corresponds to a processor that drives in accordance with a program stored in the storage part 72. The processor drives in accordance with the program so as to function as the processing unit 73.

Master data 76 of welding conditions is stored in the storage part 72 of the arithmetic processing device 7. The master data 76 is reference data of welding conditions in which values of elements (variables) included in the welding conditions are configured by reference values. In the master data 76, all the elements are set to reference values. The operator can select a welding condition of any time as the master data 76. The storage part 72 stores a change history 75 generated by the history generating unit 52 together with the master data 76. The storage part 72 stores the change history 75, which is associated with the master data 76.

The arithmetic processing device 7 of the present embodiment functions as a server that stores information related to welding conditions. In particular, the arithmetic processing device 7 functions as a server that preserves the change history 75 and the master data 76 of welding conditions. The processing unit 73 stores information related to welding in the storage part 72 and reads out the information from the storage part 72. The processing unit 73 transmits and receives information related to welding conditions to and from the condition operation unit 51.

The welding management device of the present embodiment includes the controller main body 4, the teach pendant 49, and the arithmetic processing device 7 communicably connected to the controller main body 4. In the present embodiment, the condition operation unit 51 is disposed in the controller main body 4, and the storage part 72 configured to store the change history 75 and the master data 76 is disposed in the arithmetic processing device 7 connected to the controller main body 4, but the embodiment is not limited to this. The storage part 72 may be disposed in the arithmetic processing device of the controller main body 4. In other words, the processor of the controller main body 4 may have the function of the processing unit 73, and the storage part 42 of the controller main body 4 may have the function of the storage part 72 of the arithmetic processing device 7. In this case, the welding management device can be constituted of the controller 2.

Alternatively, the processor of the arithmetic processing device 7 may carry out the function of the condition operation unit 51. In other words, the arithmetic processing device 7 may have the function of the condition operation unit 51. In this case, the welding management device can be constituted of the arithmetic processing device 7.

The welding management device of the present embodiment acquires and stores the master data of the welding condition. Then, every time the operator changes the values of at least some of the elements included in the welding condition, a change history of the welding condition is generated and stored. In other words, the welding management device adds a change history every time the welding condition is changed. Further, the welding management device restores the past welding condition based on the master data and the change history by the operation of the operator. The welding management device may display the restored welding condition on the display part, set the restored welding condition as the present welding condition, or the like.

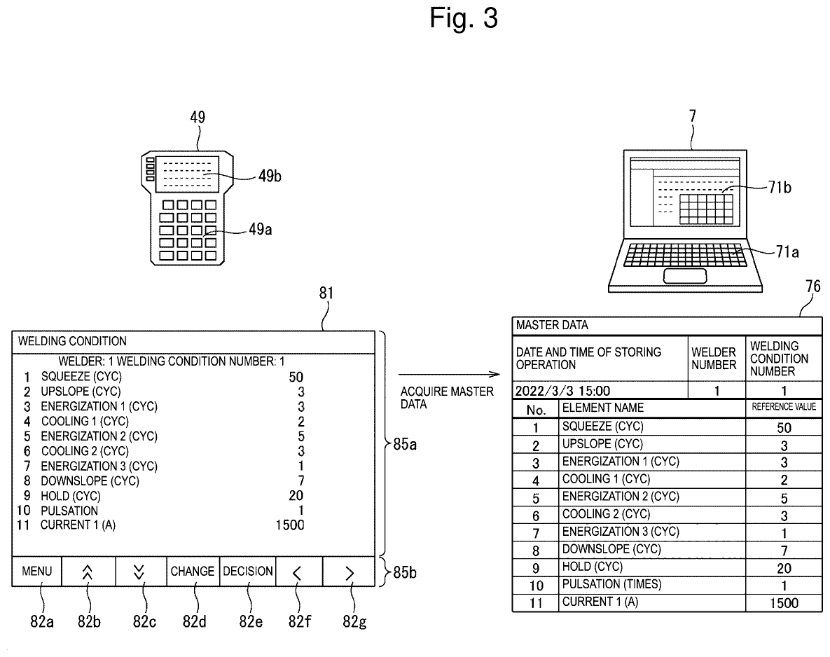

FIG. 3 is a schematic diagram describing the creation of the master data. Referring to FIG. 2 and FIG. 3, the display control unit 54 displays an image 81 including the contents of a welding condition on the display part 49b of the teach pendant 49. The image 81 includes the names of elements in the welding condition and the values of the respective elements. In this case, eleven elements such as a squeeze, an upload, and the first energization time are set as the elements in the welding condition. Times of the squeeze and the like are designated in units of cycles. In this case, one cycle is a time corresponding to a control cycle in which the processor of the welding timer transmits a current command. For example, one cycle refers to several milliseconds. In this case, the squeeze is set to a time length of 50 cycles. The welding condition includes a welder number for identifying a welder when there are a plurality of welders, and a welding condition number for specifying a desired welding condition from among a plurality of the welding conditions.

When there are a plurality of the robot apparatuses, the welder number can be set for each robot apparatus. Alternatively, the welder number may be set for each welding gun. The welding condition number can be set for each welding point (dot), for example. Alternatively, a welding condition having a common welding condition number may be used for a plurality of the welding points in a case where the states of the workpiece, such as the thickness and the material of the workpiece, are the same at the portions where welding is performed.

The robot 1 sets the welding gun 5 to a position and orientation defined by the operation program 41. In order to drive the welding gun 5, the operation program 41 includes a command regarding the drive of the electrodes 23. Further, the operation program 41 includes a command regarding welding conditions. For example, in the operation program 41, a welding condition for supplying a current to the welding gun 5 is defined by a welding condition number. When actual welding is performed, the operation control unit 43 acquires a command regarding the drive of the electrodes 23 from the operation program 41. The operation control unit 43 drives the movable electrode of the pair of electrodes 23 via the work tool drive part 45. The tool drive device 22 presses the workpieces 91 and 92 with the pair of electrodes 23.

When the workpieces 91 and 92 are pressed at a predetermined pressure, the operation control unit 43 transmits the welding condition number to the welding control unit 62. The storage part 61 of the welding timer 6 stores the welding condition 64 of each welding condition number. The storage part 61 stores the welding condition 64, in which the values of all the elements are defined. The welding control unit 62 acquires the welding condition based on the welding condition number received from the operation control unit 43. The welding control unit 62 supplies a current to the electrodes 23 in a current supply pattern in accordance with the welding condition. The members are melted and bonded to each other.

When the supply of the current in accordance with the welding condition is finished, the operation control unit 43 drives the tool drive device 22 via the work tool drive part 45 so that the electrodes 23 are separated from the workpieces 91 and 92. As discussed above, spot welding at one welding point can be performed.

The welding condition is set in advance before the actual welding work is carried out. When setting the welding condition, the operator can set the values of the respective elements of the welding condition by operating the input part 49a of the teach pendant 49. The image 81 includes an information display region 85a and a button region 85b. In the information display region 85a, information related to the welding condition is displayed. In the image 81, it is possible to set all the welding condition elements and the values with respect to the welding condition elements. In the information display region 85a, the welder number and the welding condition number are displayed.

In the present embodiment, when the value of any element of the welding condition is changed, a welding condition of a new welding condition number is not created and the present welding condition number is maintained. However, welding conditions of two or more welding condition numbers may be created for one welding point. In the present example, the welding condition of the welding condition number 1 of the first welder will be described.

In the button region 85b, there are displayed a plurality of buttons including buttons 82a to 82g for selecting an element to be displayed in the information display region 85a and changing a setting value of the element. The button 82a is a button for displaying a menu screen for selecting the content to be displayed. The buttons 82b and 82c are buttons for moving upward or downward a portion to be selected. The button 82d is a button for changing the value of the selected element. By pressing the button 82d, a screen for inputting a numerical value is displayed, and the value of the element of the welding condition can be changed.

The button 82e is a button for deciding the welding condition changed by the operator. The buttons 82f and 82g are buttons for displaying a welding condition of another welder or a welding condition of another welding condition number.

First, the operator registers master data serving as reference data of a welding condition. The operator can set a welding condition of any time in the master data. For example, the operator can set an initially created welding condition in the master data. Alternatively, the operator can set a welding condition when welding is performed as desired in the master data.

The operator selects the button 82a of the menu in the image 81. An element for registering the master data is selected from the displayed menu screen. When the operator selects registration of the master data, the condition operation unit 51 acquires a welding condition at that time as the master data. At this time, information on the date and time of data creation is added to the welding condition. Alternatively, a screen for setting the master data may be opened by pressing the button 82a of the menu and selecting a predetermined element. Then, the operator may input the value of each element of the welding condition on the screen for setting the master data so as to create the master data. The condition setting unit 55 of the condition operation unit 51 transmits the welding condition to the arithmetic processing device 7. The processing unit 73 of the arithmetic processing device 7 stores the received welding condition in the storage part 72 as the master data 76.

In FIG. 3, a plurality of the elements of the master data 76 are stored in the storage part 72 of the arithmetic processing device 7 in the form of a table. The master data 76 includes the date and time of the storing operation, the welder number, and the welding condition number. In this example, the respective reference values are as follows: 50 cycles for the squeeze, 3 cycles for the upslope, 3 cycles for the first energization time, 1500 A for the first current value, and the like. The method of preserving the master data is not limited to the table format, and values (reference values) for the respective elements can be stored in any format.

The condition setting unit 55 sets the welding condition of the master data 76 at this time as the welding condition for performing the welding. The condition setting unit 55 transmits the welding condition to the welding control unit 62 of the welding timer 6. The welding control unit 62 stores the master data in the storage part 61 as the initial welding condition 64.

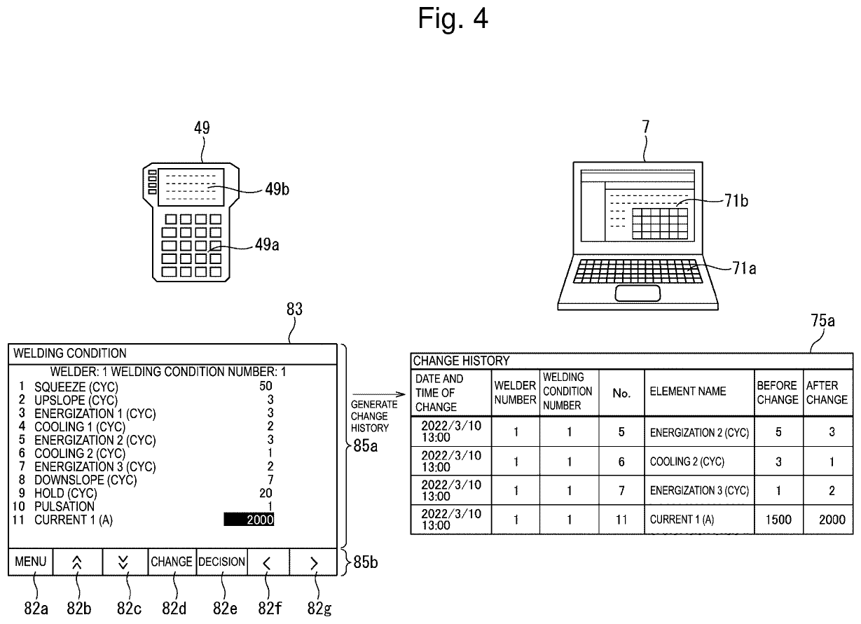

FIG. 4 is an explanatory diagram when changing values of at least some elements of the welding condition. The operator presses the button 82a on the menu to select elements for changing the welding condition. The values of the elements of the present welding condition are displayed in the information display region 85a of the display part 49b. The operator selects elements whose setting values are to be changed by operating the buttons 82b and 82c. Subsequently, when the operator presses the button 82d, an image for changing the setting values is displayed. The operator can change the setting values of the respective elements. In this example, the operator changes the setting values, and an image 83 is displayed on the display part 49b of the teach pendant 49.

The operator can change the values of the elements of the welding condition with respect to one or more elements. In this case, when the image 81 of the master data in FIG. 3 is compared with the image 83 in FIG. 4, the second energization time, the second cooling time, the third energization time, and the first current value are changed. When the change of each element of the welding condition is finished, the operator presses the button 82e to finally decide the change of the welding condition.

Referring to FIG. 2 and FIG. 4, the history generating unit 52 of the condition operation unit 51 acquires the values of the elements of the changed welding condition and the date and time of the change. The history generating unit 52 compares the welding condition of the image 81 before the change with the welding condition of the image 83 after the change. In this case, the welding condition before the change corresponds to the master data. The history generating unit 52 detects whether the values of the elements of the welding condition after the change are the same as the values of the elements of the welding condition before the change. The history generating unit 52 detects the elements where the values of the elements of the welding condition after the change are different from the values of the elements of the welding condition before the change.

Alternatively, the history generating unit 52 may detect the elements where the values of the elements of the welding condition after the change are different from the values of the elements of the welding condition before the change based on the operation of inputting the values by the operator.

The history generating unit 52 generates a change history 75a based on the detection result. The change history 75a includes the date and time of the change, the welder number, and the welding condition number. The change history 75a includes the number and the name of the changed element. The change history 75a includes a pre-change value and a post-change value for each element. For example, in the case of the second energization time, information indicating that the value is changed from 5 cycles to 3 cycles is included. As described above, in the change history of the present embodiment, the setting value of each element is stored in an absolute value. In other words, the value set by the operator is stored.

The condition setting unit 55 transmits the change history generated by the history generating unit 52 to the arithmetic processing device 7. The processing unit 73 stores the change history 75a in the storage part 72. The history generating unit 52 generates the change history 75 every time the values of at least some elements of the welding condition are changed. The storage part 72 of the arithmetic processing device 7 stores a new change history therein in such a manner that the new change history is added to the presently stored change history. In this way, the change history is stored every time the welding condition is changed.

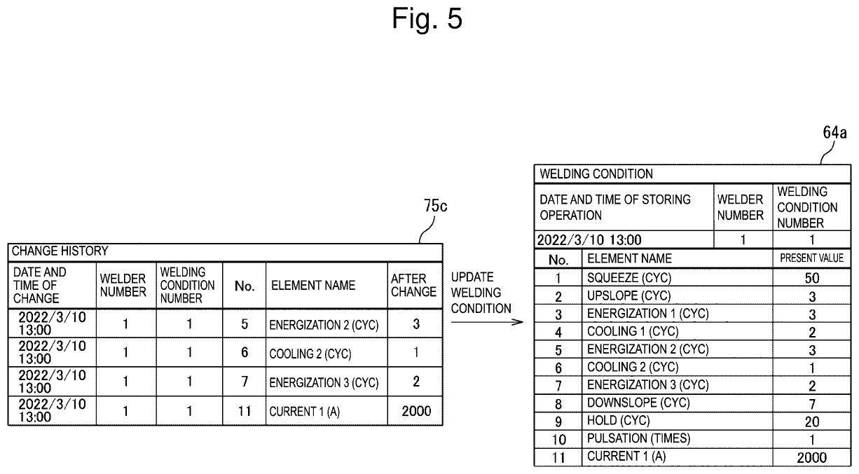

FIG. 5 is a diagram for explaining updating of a welding condition stored in the welding timer. For the changed elements, the history generating unit 52 generates a change history 75c including the values after the change. In this case, the values of the elements before the change may not be included in the change history 75c. The condition setting unit 55 transmits the change history 75c to the welding control unit 62 of the welding timer 6. The welding control unit 62 updates the welding condition 64 stored in the storage part 61 based on the change history 75c. The welding condition 64 includes the present values of all the elements.

In this example, the second energization time, the second cooling time, the third energization time, and the first current value are updated. For the elements other than the elements included in the change history 75c, the values in the welding condition stored last time are adopted. In other words, the setting values of the unchanged elements are maintained. The date and time of the storing operation is updated to the date and time of the change having been made. A welding condition 64a is stored in the form of a table in FIG. 5, but the embodiment is not limited to this. The storage part 61 can store the welding condition 64 in any form. For example, the welding condition may be generated using predetermined signs and numerals.

In this way, the condition operation unit 51 transmits the changed value to the welding timer 6. The welding control unit 62 updates the welding condition 64 based on the changed value. When welding is actually performed, the welding control unit 62 supplies a current based on the updated welding condition 64.

The operator can change the welding condition at desired time. For example, the operator can change the value of any element of the welding condition based on the state of the actually performed welding (quality of the welding). The history generating unit 52 generates a change history when the welding condition is changed. The processing unit 73 of the arithmetic processing device 7 receives the change history and stores it in the storage part 72. The welding control unit 62 of the welding timer 6 receives the change history and updates the welding condition 64. In this way, the operator can change the welding condition a plurality of times until the welding can be performed in the desired state.

The operator may change the master data at any time. For example, the operator registers an initial welding condition as master data. Then, the operator changes the welding condition so as to acquire the welding condition when the welding quality is optimum. The operator may store the welding condition at this time as the master data.

When the master data is changed, the history generating unit generates a change history between the master data before the change and the master data after the change, similarly to the change history of the welding condition described above. In other words, the history generating unit compares the master data before the change with the master data after the change. The history generating unit generates, for a changed element, a change history of the master data including a value of the element before the change and a value of the element after the change. The change history of the master data is stored in the storage part 72 of the arithmetic processing device 7.

Thereafter, the processing unit 73 may delete the master data before the change. On the other hand, the operator may want to check the past change history in some cases. Because of this, the regular change history before the time when the post-change master data was created is not deleted but preserved.

Then, based on the master data 76 and the change history 75, the welding management device in the present embodiment can calculate the welding condition adopted at a predetermined time point. For example, the welding management device can restore the values of all the elements of the welding condition at a desired time point in the past. Alternatively, the welding management device can calculate the values of all the elements of the present welding condition by the same method. In this case, the restoration of a welding condition at a desired time point in the past will be described.

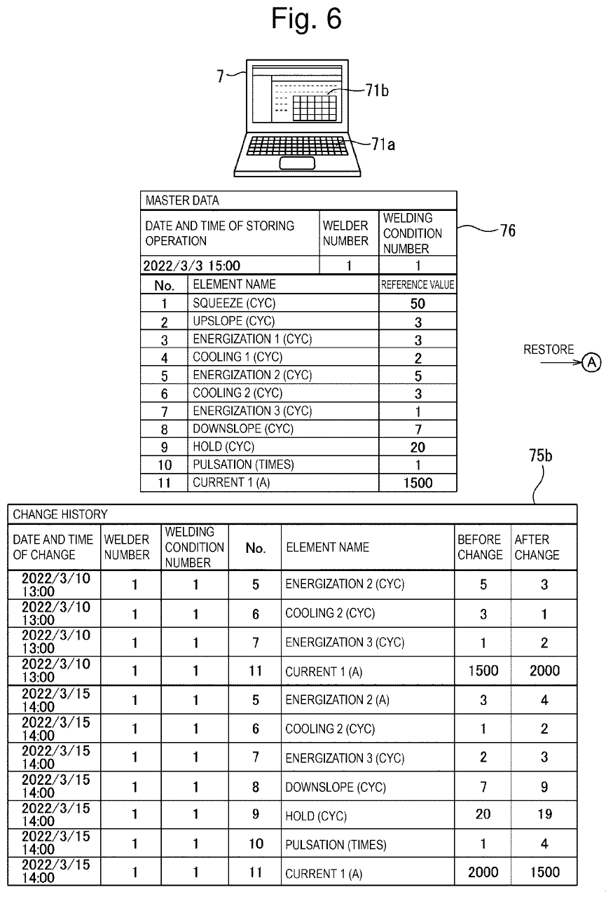

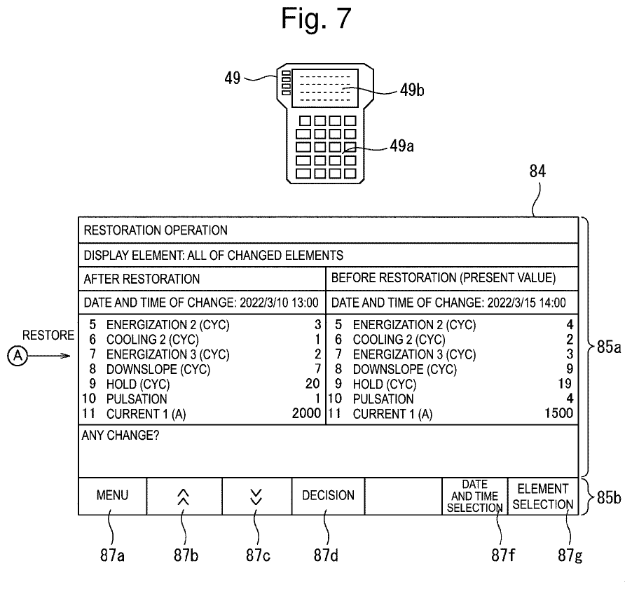

FIG. 6 illustrates a first diagram for explaining the restoration of a welding condition adopted in the past. FIG. 7 illustrates a second diagram for explaining the restoration of a welding condition adopted in the past. Based on the data stored in the arithmetic processing device 7 of FIG. 6, the values in the welding condition after the restoration displayed on the teach pendant 49 of FIG. 7 are calculated. Referring to FIG. 2, FIG. 6, and FIG. 7, the storage part 72 of the arithmetic processing device 7 stores the master data 76 and a change history 75b to which a history is added every time a welding condition is changed. The change history 75b depicted in FIG. 6 includes a history changed on Mar. 10, 2022 and a history changed on Mar. 15, 2022. The present welding condition is a condition after being changed on Mar. 15, 2022.

The restoring unit 53 of the condition operation unit 51 restores the welding condition adopted in the past based on the master data 76 and the change history 75b. On the display part 49b of the teach pendant 49, there is displayed an image 84 including the values of the elements of the present welding condition and the values of the elements after the restoration performed at the time selected by the operator.

The operator specifies the date and time of the change performed in the past included in the change history. The restoring unit 53 restores the values of at least some of the elements of the welding condition at the time point specified by the operation of the operator. The restoring unit 53 extracts a change history from the date and time when the master data 76 was created to the specified date and time. The restoring unit 53 restores the welding condition after the change performed at the specified date and time, based on the master data 76 and the change history up to the specified date and time. In this example, the past date and time specified by the operator is Mar. 10, 2022, and the welding condition after the change on that date is calculated and displayed.

The values of the elements of the present welding condition can be derived by the same control as the above-discussed control. In other words, the present welding condition can be calculated based on the master data 76 and the change history 75 without acquiring the present welding condition from the welding timer 6.

For example, the operator selects a button 87a of the menu on the teach pendant 49 to select an element of a restoration operation. By selecting a button 87f, an image of a list of dates and times at which changes included in the change history were made is displayed. The operator selects the date and time for restoring the past welding condition.

The restoring unit 53 calculates the values of the respective elements so that the welding condition after the change at the date and time specified by the operator is obtained. For example, when the welding condition is changed a plurality of times from the present to the specified date and time, the restoring unit 53 can derive the values obtained by returning the values of all the elements to the values at the specified date and time.

The display part 49b can display the values of the elements employed in the past and restored by the restoring unit 53. In this example, the display control unit 54 displays, on the display part 49b, a list of the values of the elements of the welding condition adopted in the past and the values of the elements of the present welding condition, for the elements of the welding condition whose values are to be changed by restoration. In other words, the elements to be changed by restoration are extracted, and the present values before restoration and the values after restoration are displayed side by side. By performing this control, the operator can easily grasp all the elements of the welding condition having been changed from the specified date and time to the present.

An image when performing the restoration operation is not limited to this form, and all the welding condition elements may be displayed. In other words, elements of the welding condition having no change from the present to the specified date and time may also be displayed. In the welding management device of the present embodiment, the operator can easily acquire the elements having changed the welding condition and the changed values. For this reason, the operator can easily manage the welding condition.

By viewing the image 84, the operator can easily understand the element to be changed by the restoration. In addition, the operator can easily grasp the elements having been changed from the specified date and time to the present. The operator determines whether or not to perform restoration to the welding condition of the specified date and time. When changing the welding condition, the operator selects the welding condition of another date and time by pressing the button 87f.

The operator presses a button 87d when finally deciding the welding condition to be restored. The condition setting unit 55 sets the restored welding condition as a welding condition under which the current welding is performed. The history generating unit 52 generates a change history based on the values of the present welding condition and the values of the changed welding condition. The condition setting unit 55 transmits the change history to the arithmetic processing device 7. The storage part 72 of the arithmetic processing device 7 stores the change history. The condition setting unit 55 transmits the change history including the values of the elements after the change to the welding control unit 62. The welding control unit 62 updates the welding condition 64 stored in the storage part 61. The history generating unit may add, to the change history, information indicating that the past welding condition has been restored.

As described above, in the present embodiment, the restoring unit 53 restores the values of at least some of the elements for the welding condition at the time point specified by the operation of the operator. The restoring unit 53 acquires the change history 75 and the master data 76 from the arithmetic processing device 7 and restores the past welding condition. The display control unit 54 can display, on the display part 49b, the values of the elements employed in the past, which are calculated by the restoring unit 53. The operator can easily compare the past welding condition with the present welding condition.

For example, the quality of welding may deteriorate at a predetermined time. The operator can investigate the cause of the deterioration in the welding quality by referring to the past change of the welding condition. When the change of the welding condition is the cause of the deterioration in the welding quality, it is possible to perform an operation of restoring the welding condition to the welding condition having been set immediately before the time when the deterioration in the welding quality was caused.

In the present embodiment, control is performed in such a manner as to restore the welding condition to the welding condition having been changed in an immediately previous stage, but the embodiment is not limited to this. The control may be performed in such a manner as to restore the welding condition to the welding condition having been changed earlier by two or more stages. The elements to be changed are not limited to some of the elements of the welding condition, and all the elements may be changed.

In the present embodiment, master data and a change history starting from the master data are stored in order to manage a welding condition. As the change history, actual values are stored without adopting a difference between a value before change and a value after change. By adopting this configuration, it is possible to reliably restore the welding condition at a desired time point. For example, in a case where there is no master data and there is only difference information, when part of the difference information is lost for some reason, the welding condition may not be restored. Alternatively, when the difference information is changed for some reason, the welding condition may not be restored. However, by including the master data and the change history indicated by the absolute values, it is possible to reliably restore the welding condition at an optional time point.

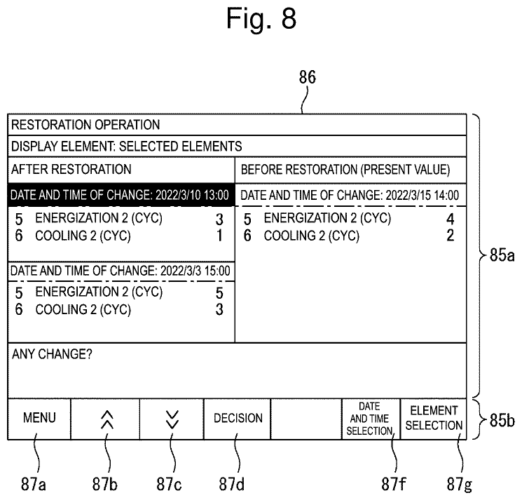

FIG. 8 illustrates an example of an image that is displayed on the display part of the teach pendant when some elements of the welding condition are restored. When the operator selects a button 87g, another screen is opened and the operator selects a desired element from among the elements of the welding condition. For example, on the other screen, a list of elements of the welding condition having been changed from the creation of the master data to the present is displayed. The operator can select a desired element from the list of elements. In an image 86, the operator selects the second energization time and the second cooling time from among the elements changed in the past.

The restoring unit 53 can extract, from the change history, the date and time of the change of the elements selected by the operator and a numerical value of each selected element. In this case, two elements set on Mar. 10, 2022 and Mar. 3, 2022, and the values thereof are displayed. The display control unit 54 can display the present values of the selected elements, and display the values of the selected elements at the respective dates and times of the change.

The operator can select the date and time of the change by operating buttons 87b and 87c. Then, the operator can restore the selected element to the value of the selected date and time by pressing the button 87d for decision. For the elements other than the selected element, the present values thereof are maintained.

As described above, the restoring unit 53 can restore the values of some elements among a plurality of the elements changed in the past. The restoring unit 53 can restore some elements included in the welding condition employed in the past at a predetermined time point. The condition setting unit 55 can set the values of some elements of the restored welding condition of the past as the values of some elements of the welding condition under which the current welding is performed.

In this case as well, the history generating unit 52 generates a change history. The condition setting unit 55 transmits the change history including the values of the elements before the change and the values of the elements after the change to the processing unit 73 of the arithmetic processing device 7. The processing unit 73 stores the change history in the storage part 72. The condition setting unit 55 transmits the change history including the values of the elements after the change to the welding control unit 62. The welding control unit 62 updates the welding condition 64 by the values after the change. As described above, the welding management device of the present embodiment can perform the operation of restoring the values of some elements of the welding condition to which the operator pays attention.

The welding management device of the present embodiment facilitates the management of changes in the welding conditions. Therefore, in a case where a problem occurs in the quality of welding, the cause of the problem can be easily identified, and repair and restoration can be easily carried out. For example, it is possible to easily determine the change of the welding condition that causes the occurrence of the problem and return the welding condition to the original state.

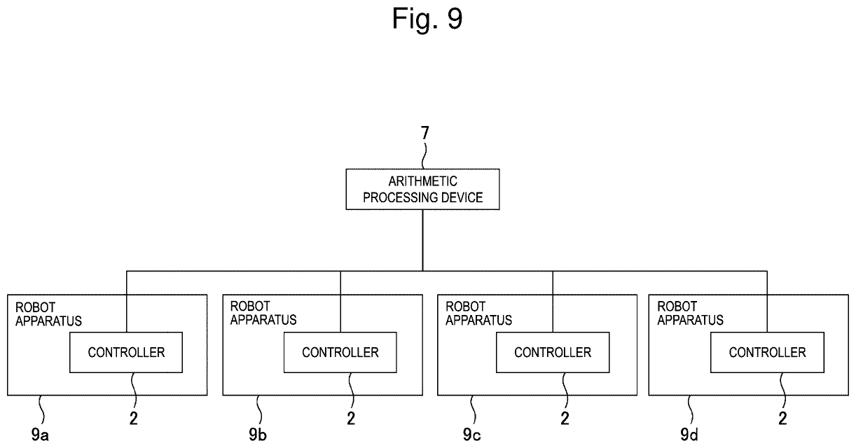

FIG. 9 is a block diagram of another robot system in the present embodiment. The other robot system includes robot apparatuses 9a to 9d as a plurality of welding apparatuses. In this example, the robot system includes four robot apparatuses 9 a to 9 d with welder numbers being 1 to 4.

In the robot system described above, the arithmetic processing device 7 is directly connected to the controller 2 of the robot apparatus 9. In contrast, in the other robot system, a storage part of an arithmetic processing device 7 functioning as a server is connected to a plurality of the robot apparatuses 9a to 9d via an electric communication line. The arithmetic processing device 7 is connected to controllers 2 of the robot apparatuses 9a to 9d via, for example, an intranet such as a local area network (LAN) or a network such as the Internet.

In particular, the arithmetic processing device 7 is formed to be able to communicate with a condition operation unit of the robot apparatus 9a. The storage part of the arithmetic processing device 7 acquires information about the robot apparatuses 9a to 9c such as welding conditions from the respective controllers 2, and stores the acquired information therein. In particular, a condition setting unit of the controller 2 transmits a change history of the welding condition and master data to the arithmetic processing device 7.

In the other robot system, the welding conditions can be collectively managed for the plurality of robot apparatuses. For example, change histories of the welding conditions can be collectively managed. Alternatively, changes in the values of the elements of the welding conditions can be collectively checked for the plurality of robot apparatuses. As a result, in a case where a problem occurs in the quality of welding, the problem can be easily detected. Alternatively, in a case where the plurality of robot apparatuses are disposed in one production line, it is possible to easily detect a problem as a problem in the entire production line.

It is preferable that forms of welding such as thicknesses, shapes, and materials of workpieces be the same at least at some welding points, in the respective robot apparatuses 9a to 9d. In other words, in the robot apparatuses 9a to 9d, it is preferable that a welding condition of a common welding condition number be able to be used with respect to at least some of the welding points. The arithmetic processing device 7 can transmit, to all the robot apparatuses, the optimum welding condition for the welding points in the same form.

In the present embodiment, a robot apparatus provided with a spot welding gun and a robot attached with the spot welding gun is exemplified and explained, but the embodiment not limited to this. The welding management device in the present embodiment can be applied to the management of any spot welding apparatus. For example, a spot welding apparatus may be configured in such a manner that a workpiece is moved while a spot welding gun is fixed.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

1. A welding management device configured to manage a welding condition of spot welding, the welding management device comprising:
a storage part configured to store reference data of a welding condition in which a value of an element included in the welding condition is configured by a reference value; and
a history generating unit configured to generate, when a value of at least one element of the welding condition is changed, a change history including a value before the change and a value after the change of the at least one element, wherein
the storage part stores the change history generated by the history generating unit together with the reference data.

2. The welding management device of claim 1, comprising a restoring unit configured to restore a value of an element of a past welding condition, wherein the restoring unit restores the past welding condition based on the reference data and the change history.

3. The welding management device of claim 2, comprising a condition setting unit configured to set a welding condition under which welding is actually performed, wherein
the restoring unit restores a welding condition adopted in the past at a predetermined time point, and
the condition setting unit sets the welding condition restored by the restoring unit as a welding condition under which current welding is performed.

4. The welding management device of claim 3, comprising a display part configured to display information related to welding, wherein
the display part displays, for a welding condition element whose value is to be changed, a list of values of the welding condition elements adopted in the past and values of the welding condition elements at present.

5. The welding management device of claim 2, comprising a condition setting unit configured to set a welding condition under which welding is actually performed, wherein
the restoring unit restores some elements included in a welding condition adopted in the past at a predetermined time point, and
the condition setting unit sets values of some elements of the welding condition restored by the restoring unit to a welding condition under which current welding is performed.

6. The welding management device of claim 2, comprising a display part configured to display information related to welding, wherein
the restoring unit restores values of at least some elements of a welding condition at a time point specified by an operation of an operator, and
the display part displays values of the elements adopted in the past and restored by the restoring unit.

7. The welding management device of claim 1, wherein
the storage part is connected to a plurality of welding apparatuses via a network, and
the storage part is configured to store information about the plurality of welding apparatuses.
